(19) United States
(12) Patent Application Publication
(10) Pub. No.: US 2014/0197222 A1
(43) Pub. Date: Jul. 17, 2014

(54) CABLE CLIP GUN

(71) Applicant: Howe Renovation (Yorks) Limited, North Lincolnshire (GB)

(72) Inventor: Anthony Richard Howe, North Lincolnshire (GB)

(73) Assignee: Howe Renovation (Yorks) Limited, North Lincolnshire (GB)

(21) Appl. No.: 14/160,213

(22) Filed: Jan. 21, 2014

Related U.S. Application Data
(63) Continuation-in-part of application No. PCT/GB2012/000264, filed on Mar. 23, 2012.

(30) Foreign Application Priority Data
Jul. 20, 2011 (GB) 11125093
Jun. 28, 2013 (GB) 13116165
Jun. 28, 2013 (GB) 13116181

(51) Int. Cl. H02G 3/32; B25C 1/00; B25C 1/06

(52) U.S. Cl. CPC H02G 3/32; B25C 1/06; B25C 1/001
USPC 227/109; 227/120; 227/131

(57) ABSTRACT

The invention relates to a cable clip gun (1) for securing clips (10) with a pin (11) into a surface Y. Gun (1) has a gun body, storage means (4) to store a plurality of clips, a driver station (5), a delivery means (4) to deliver a clip from the storage to the driver station, and a driver (6) to drive the clip pin into the surface to secure the cable to the surface.

### FIELD OF THE INVENTION

The present invention relates to a cable clip gun and to a magazine for a cable clip gun.

### BACKGROUND OF THE INVENTION

It is often desirable to lay a cable along a wall, along a skirting board or around a door frame. It is sometimes desirable to place cable clips onto surfaces which are not flat such as mortar recessed between rows of bricks. Such a cable might be a television aerial cable, telephone cable, mains electric cable, or loudspeaker cable. One method of doing this is by the use of cable clips which need to be nailed into place individually by the by a person who would obtain each clip from a container or box. It is time consuming task hammering each clip one by one into a surface and measuring the distance between each clip. It is also easy for a person to damage their fingers and the cable itself by this hammering operation.

### Problem to be Solved by the Invention

There is a need for an improved apparatus and method for fixing cable clips.

### SUMMARY OF THE INVENTION

According to a first aspect of the invention there is provided a cable clip gun for securing clips with a pin over a cable into a surface comprising:

a) a gun body,

b) a storage means to store a plurality of clips

c) a driver station

d) a delivery means to deliver a clip from the storage means to the driver station; and preferably

e) a driver means to drive a clip at the driver station into a surface or workpiece and drive the pin into the surface or workpiece to secure the clip.

Preferably, the driver station is configured to deliver a clip into a workpiece.

In a second aspect of the invention there is provided a cable clip gun for securing clips with a pin over a cable into a surface comprising:

a) a gun body,

b) storage means to store a plurality of clips,

c) a cable guide to guide cable through to a driver station,

d) delivery means to deliver a clip from the storage means over the cable at the driver station, and

e) a driver to drive the clip pin into the surface to secure the cable to the surface.

In a third aspect of the invention, there is provided a cable clip gun for securing clips with a pin into a surface comprising:

a) a gun body,

b) storage means to store a plurality of clips each with a pin,

c) a driver station, said driver station including a projection to project into a recess in a workpiece,

d) delivery means to deliver a clip from the storage means to the driver station, and

e) a driver means to drive the clip at the driver station through the projection and drive the pin into the surface to secure the clip to the surface.

Preferably the projection includes a cutout to receive cable when a clip is being secured over a cable.

In a fourth aspect of the invention, there is provided a cable clip gun for securing clips with a pin into a surface comprising:

a) a gun body,

b) at least one magazine to store a plurality of clips each with a pin and the or each magazine is adapted to releasably engage with the gun body,

c) a driver station to deliver a clip into a workpiece. and

d) delivery means to deliver a clip from the magazine to the driver station.

### ADVANTAGES OF THE INVENTION

The cable clip gun and method of using it provide an improvement in the speed, efficiency and accuracy of affixing cable clips to surfaces and to secure cables.

### BRIEF DESCRIPTION OF THE DRAWINGS

FIG. 1 shows in perspective view a cable clip gun according to the second aspect of the invention;

FIG. 2 shows in perspective view a cable clip gun according to the third aspect of the invention;

FIG. 3 shows in perspective view a cable clip gun according to one embodiment of the fourth aspect of the invention; and

FIG. 4 shows in perspective view a cable clip gun according to a second embodiment of the fourth aspect of the invention.

### DETAILED DESCRIPTION OF THE INVENTION

The present invention in its various aspects provides a cable clip gun for securing clips with a pin over a cable into a surface

Preferably the driver is a hammer.

Preferably the clips are in the form of an array of clips joined together by frangible bridging means.

Preferably the driver means severs a clip being secured to a cable from the array of clips. Optionally, a clip from an array of clips joined together by frangible bridging means may be individually removed from the array by an operator who may opt to affix specific clips by hand (e.g. by pin and hammer into the surface).

Preferably the driver means is adjustable to drive a clip pin at variable forces.

Preferably the driver means is electrically operated.

Preferably the gun further comprises a metering means to secure a clip over the wire at predetermined intervals.

Preferably the gun is adapted to accommodate different sizes of cable and clips.

Optionally, clip sizes that may be used include 2.5 mm, 3.5 mm, 4 mm, 5 mm, 6, mm, 7 mm, 8, mm, 9 mm, 10 mm, 12 mm 14 mm, 16 mm, 18 mm, 20 mm, 22 mm and 25 mm.

In one aspect (the fourth) of the invention, the storage means is provided by a magazine to store a plurality of clips, each with a pin and the or each magazine is adapted to releasably engage with the gun body. In one embodiment of the fourth aspect, the magazine may preferably releasably engage with a recess in the gun body to create a flat surface and preferably the magazine creates a channel along the flat edge to receive a cable. In another embodiment, the magazine releasably engages with a recess in the gun boy to create a projection at the driver station to insert in a recess in a workpiece. Different magazines may be provided to house different sizes and types of clips for a single clip gun.

Embodiments of the invention will now be described with reference to the accompanying drawings.

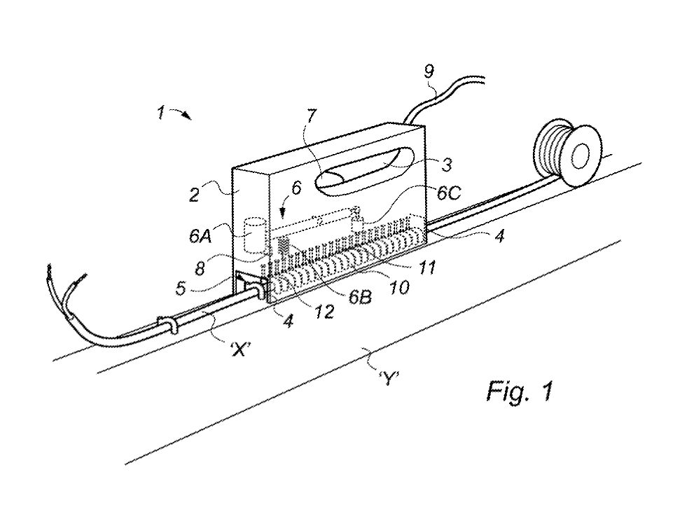

Referring to FIG. 1 there is shown a cable gun 1, according to one embodiment/aspect (the second) of the invention, for securing clips 10 with a pin 11 over a cable X into a surface such as a skirting board Y.

Gun 1 has a gun body 2 with a handle 3 to hold the gun onto the cable X and skirting board Y. An elongate channel 4 provides a storage means to store a plurality of clips 10 with pins 11. Clips 10 may be formed as an array of clips in a strip joined together by frangible bridging means 12.

Elongate channel 4 acts also as a cable guide to guide cable through a driver station 5. Elongate channel 4 also acts as a delivery means to deliver a clip from the storage means over the cable at the driver station 5.

A driver 6 is provided to drive the clip pin 11 at the driver station 5 into the surface Y to secure the cable X to the surface Y. Driver 6 is a hammer with a head 6A biased by a spring 6B towards a pin 11, and head 6A can be pivoted away from pin 11 by an electrical solenoid 6C. Driver 6 can be operated by a trigger 7. Operation of trigger 7 causes solenoid 6 to pivot head 6A away from pin 11 so stretching spring 6B and then turns solenoid 6C “off whereby the spring 6B drives hammer head 6A onto the pin 11 so driving the pin into the surface Y. Hammer head 6A includes a cutter 8 which cuts through the frangible bridging means so severing the clip at the driver station 5 from the array of clips in channel 4. Power for solenoid 6C is provided from the mains through wire 9.

In use the gun is used to guide the cable X along a surface such as skirting board Y, and the trigger 7 used to secure a clip 10 over the cable as required. If desired, the driver means may be adjustable, e.g. by altering the tension of spring 6B when stretched by the solenoid 6C, to drive a clip pin at variable forces. Thus a different force could be used to drive a pin 11 depending on the nature of the surface it is being driven into (e.g. brick, wood, plastic or plaster).

Furthermore the gun may further comprise a metering means to secure a clip over the wire at predetermined intervals automatically. A control knob (not shown) may be provided to adjust the predetermined interval.

Also the gun may be adapted to accommodate different sizes of cable and clips.

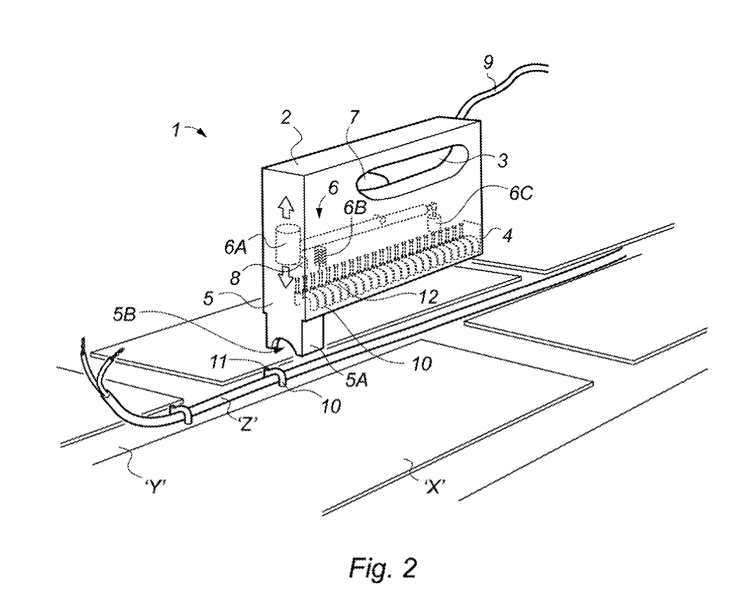

Referring to FIG. 2 there is shown a cable gun 1, according to another embodiment/aspect (the third) of the invention, for securing clips 10 with a pin 11 into a surface such as mortar Y recessed between bricks X.

Gun 1 has a gun body 2 with a handle 3 to hold the gun adjacent a surface such as bricks X.

An elongate channel 4 provides a storage means to store a plurality of clips 10 with pins 11. Clips 10 may be formed as an array of clips in a strip joined together by frangible bridging means 12. Elongate channel 4 also acts as a delivery means to deliver a clip from the storage means to a driver station 5.

Driver station 5 includes a projection 5A to project into a recess in a workpiece such as recessed mortar Y between bricks X.

A driver 6 is provided to drive the clip pin 11 at the driver station 5 into the surface Y to secure the cable Z to the surface Y. Driver 6 is a hammer with a head 6A biased by a spring 6B towards a pin 11, and head 6A can be pivoted away from pin 11 by an electrical solenoid 6C. Driver 6 can be operated by a trigger 7. Operation of trigger 7 causes solenoid 6 to pivot head 6A away from pin 11 so stretching spring 6B and then turns solenoid 6C “off” whereby the spring 6B drives hammer head 6A onto the pin 11 so driving the pin into the surface Y. Hammer head 6A includes a cutter 8 which cuts through the frangible bridging means so severing the clip at the driver station 5 from the array of clips in channel 4. Power for solenoid 6C is provided from the mains through wire 9.

Preferably the projection 5A includes a cutout 5B to receive cable when a clip is being secured over a cable.

If desired the driver means may be adjustable, e.g. by altering the tension of spring 6B when stretched by the solenoid 6C, to drive a clip pin at variable forces. Thus a different force could be used to drive a pin 11 depending on the nature of the surface it is being driven into (e.g. brick, wood, plastic or plaster).

Furthermore the gun may further comprise a metering means to secure a clip over the wire at predetermined intervals automatically. A control knob (not shown) may be provided to adjust the predetermined interval.

Also the gun may be adapted to accommodate different sizes of cable and clips. The clips may be standard clips which are secured to a workpiece over a cable, or the clips may be of type described in UK patent application nos. GB1121713.0 or GB1117952.0, the disclosure of which is incorporated herein in their entirety by reference.

It may be desirable for any clip to be held at the driver station against a workpiece with pressure as the driver drives the pin into the workpiece, and a suitable device may be provided for this purpose.

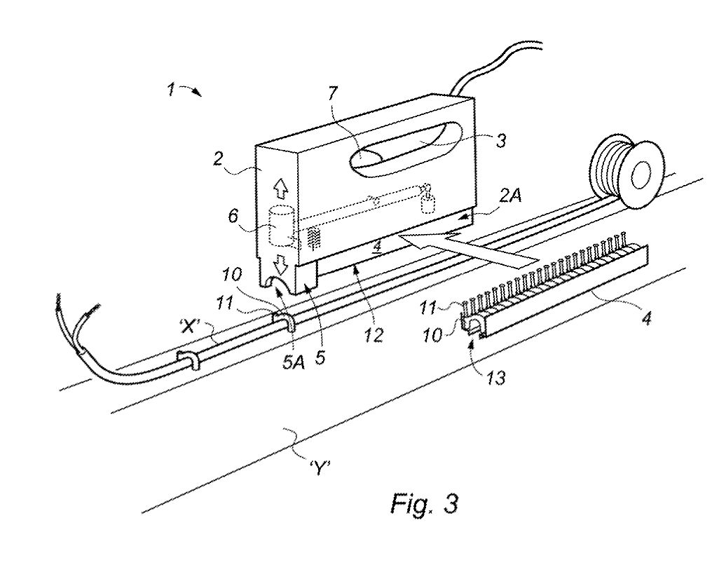

Referring to FIG. 3 there is shown a cable gun 1, according to a further embodiment/aspect (the fourth) of the invention, for securing clips 10 with a pin 11 over a cable X into a surface such as a skirting board Y. Gun 1 has a gun body 2 and a handle 3.

An elongate magazine 4 provides a storage means to store a plurality of clips 10 with pins 11. Magazine 4 is removeable and engages with a recess 2A in body 2.

When magazine 4 releasably engages with a recess 2A in the gun body, it creates a flat edge 12 to the gun body to abut against a flat surface. The magazine has a channel recess 13 along the flat edge to receive a cable.

Magazine 4 acts also as a cable guide to guide cable through a driver station 5. Magazine 4 also acts as a delivery means to deliver clips 10 to a driver station 5 with a cable recess 5A which aligns with the channel 12 so that the cable is recessed into the flat edge 12.

A driver 6 operated by trigger 7 is provided to drive the clip pin 11 at the driver station 5 as described hereinbefore an in relation to FIG. 1 above.

In use the gun is used to guide the cable X along a surface such as skirting board Y, and the trigger 7 used to secure a clip 10 over the cable as required.

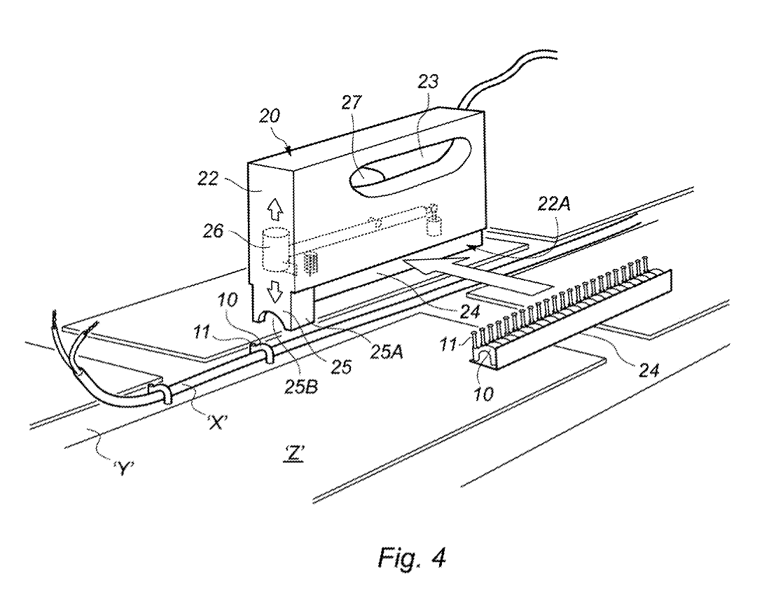

Referring now to FIG. 4, there is shown a cable gun 20, according to a further embodiment/aspect (the fourth) of the invention, for securing clips 10 with a pin 11 over a cable X into a surface such as mortar Y recessed between bricks Z. Gun 20 has a gun body 22 and a handle 23.

An elongate magazine 24 provides a storage means to store a plurality of clips 10 with pins 11. Magazine 24 is removeable and engages with a recess 22A in body 22.

When magazine 24 releasably engages with a recess 22A in the gun body, because it is thinner than the recess, creates a projection 25A at a driver station 5 to abut against the recessed mortar surface Y. Gun 20 thus performs like the gun described hereinbefore (e.g. according to the third aspect of the invention) and with reference to FIG. 2.

Magazine 24 also acts as a delivery means to deliver clips 10 to the driver station 25 with a cable recess 25B so that the cable is recessed into the recess 25B.

A driver 26 operated by trigger 27 is provided to drive the clip pin 11 at the driver station 25 as described hereinbefore, e.g. with reference to FIG. 1 and the second aspect of the invention.

It is envisaged that numerous magazines could be provided each supporting clips of different types to accommodate different sizes of cable and clips. The clips may be standard clips which are secured to a workpiece over a cable, or the clips may be of type described in UK patent application nos. GB1121713.0 or GB1117952.0, the disclosure of which is incorporated herein in their entirety by reference. Also it may be desirable to secure two or more cables to a surface with a single clip. In addition to clips, the magazine could accommodate hooks or other devices to secure Christmas lights and the like to walls.

It may be desirable for any clip to be held at the driver station against a workpiece with pressure as the driver drives the pin into the workpiece, and a suitable device may be provided for this purpose.

The invention has been described with reference to preferred embodiments. However, it will be appreciated that variations and modifications can be effected by a person of ordinary skill in the art without departing from the scope of the invention.

1. A cable clip gun for securing clips with a pin over a cable into a surface comprising:
a) a gun body,
b) a storage means to store a plurality of clips, each with a pin
c) a driver station
d) a delivery means to deliver a clip from the storage means to the driver station; and
e) a driver means to drive a clip or clip pin into a surface or workpiece.

2. A cable clip gun according to claim 1, wherein the driver station is configured to deliver a clip to a workpiece or surface.

3. A cable clip gun according to claim 1, which further comprises a cable guide to guide cable through to the driver station.

4. A cable clip gun according to claim 1, wherein the delivery means delivers a clip from the storage means over the cable at the driver station.

5. A cable clip gun according to claim 1, wherein the driver means is a hammer.

6. A cable clip gun according to claim 5, wherein the driver means comprises a hammer with a head biased by a spring towards a pin, said head being pivotable away from the pin by an electrical solenoid.

7. A cable clip gun according to claim 6, wherein the driver is operated by a trigger, whereby the trigger controls an electrical source of power to the electrical solenoid.

8. A cable clip gun according to claim 1, wherein the clips are in the form of an array of clips joined together by frangible bridging means.

9. A cable clip gun according to claim 8, wherein the driver means severs a clip being secured to a cable from the array of clips.

10. A cable clip gun according to claim 1, wherein the driver means is adjustable to drive a clip pin at variable forces.

11. A cable clip gun according to claim 1, wherein the driver means is electrically operated.

12. A cable clip gun according to claim 1, wherein the storage means comprises an elongate channel in the gun configured to store a plurality of clips.

13. A cable clip gun according to claim 12, wherein the elongate channel incorporates means to guide the cable.

14. A cable clip gun according to claims 13, wherein the elongate channel acts as a delivery means to deliver a clip from the storage means and over a cable.

15. A cable clip gun according to claim 1, wherein the gun further comprises a metering means to secure a clip over the cable at predetermined intervals.

16. A cable clip gun according to claim 1, wherein the gun is adapted to accommodate different sizes of cable and clips.

17. A cable clip gun according to claim 1, wherein the driver station includes a projection to project into a recess in a workpiece and the driver means is to drive the clip at the driver station through the projection and drive the pin into the surface to secure the clip to the surface.

18. A cable clip gun according to claim 17, wherein the projection includes a cutout to receive cable when a clip is being secured over a cable.

19. A cable clip gun according to claim 1, wherein the storage means comprises at least one magazine configured to store a plurality of clips each with a pin and the or each magazine is adapted to releasably engage with the gun body and the delivery means is configured to deliver a clip from the magazine to the driver station.

20. A cable clip gun according to claim 19, wherein the magazine releasably engages with a recess in the gun body to create a flat edge to the gun body to abut against a flat surface.

21. A cable clip gun according to claim 20, wherein the magazine creates a channel along the flat edge to receive a cable.

22. A cable clip gun according to claim 19, wherein the magazine releasably engages with a recess in the gun body to create a projection at the driver station to insert in a recess in a workpiece.

23. A cable clip gun according to claim 19, wherein different magazines may be provided to house different sizes and types of clips for a single cable gun.

24. A magazine for use with a cable clip gun of claim 19, the magazine configured to store a plurality of clips each with a pin and the magazine adapted to releasably engage with a gun body.

25. An array of clips, e.g. in the form of a strip or belt of clips, joined together by frangible bridging means.
